(19) United States
(12) Patent Application Publication
(10) Pub. No.: US 2006/0242613 A1
(43) Pub. Date: Oct. 26, 2006

(54) Automatic floorplanning approach for semiconductor integrated circuit

(76) Inventor: Hiromasa Fukazawa, Hyogo (JP)

Correspondence Address: MCDERMOTT WILL & EMERY LLP, 600 13TH STREET, N.W., WASHINGTON, DC, 20005-3096, US

(21) Appl. No.: 11/405,578

(22) Filed: Apr. 18, 2006

(30) Foreign Application Priority Data
Apr. 20, 2005 (JP) 2005-122740

(51) Int. Cl. G06F 17/50

(52) U.S. Cl. 716/8

(57) ABSTRACT

In an automatic floorplanning approach, flexibility is given to the shape and area of a black-box block set in advance, so that the shape and area of the black-box block are made to reflect influences of line congestion and the like at the chip level, and also become less influential on blocks other than the black-box block.

### BACKGROUND OF THE INVENTION

The present invention relates to an automatic floorplanning approach for blocks of logic cells, memories and the like in a semiconductor integrated circuit, and more particularly, to an automatic floorplanning approach for solving problems related to routing, timing, voltage dropping and the like in a semiconductor integrated circuit having a hierarchical layout structure involving a black-box block.

In recent years, with increase in the scale of semiconductor integrated circuits, hierarchical design in which a circuit is divided into a plurality of blocks and the blocks are later assembled together has become an indispensable approach in the design process. The hierarchical design enables a designer to handle a large capacity, and also provides effects such as reduction in design time period since the divided blocks can be designed in parallel.

To be successful in the hierarchical design approach, it is important to determine the placement position, shape and area of each block in floorplan design so as to be optimum when viewed from the chip level after assembling of the divided blocks. The reason for this is that the placement position, shape and area of each block greatly affect the problems related to routing, timing, voltage dropping, areas and the like at the chip level after assembling of the divided block.

The determination of the placement position and the like of each block was conventionally made by examining them on paper. At present, virtual flat placement with an automatic floorplanning tool is becoming mainstream as a technology of efficiently deriving more optimal placement, shapes and areas of blocks. The virtual flat placement is a technology of placing logical cells, memories and the like flatly at the chip level tentatively neglecting the hierarchical structure of the circuit. Based on the resultant placement, the placement position, shape and area of each block are determined with an automatic floorplanning tool.

With use of the virtual flat placement, the position, shape and area of each block do not affect the routing, timing, voltage dropping, areas and the like at the chip level after assembling of the divided blocks, but, contrarily, the routing, timing, voltage dropping, areas and the like at the chip level come to affect the determination of the placement position, shape and area of each block. Resultantly, the placement position, shape and area of each block can be determined to be optimum when viewed from the chip level after assembling of the divided blocks.

In the automatic floorplanning approach in hierarchical layout design adopting the virtual flat placement technology, when virtual flat placement processing is executed, a block in the state of a so-called black box, in which only input and output information at the block boundaries is available and internal logic cells, memories and the like are unknown because development of the semiconductor integrated circuit has just started or is delayed, is assumed to have a fixed shape and area set in advance with reference to the past design events and the like.

Since the virtual flat placement processing is executed while the shape and area of a black-box block are kept fixed, the shape and area of the black-box block will be determined without satisfactorily reflecting influences of the routing, timing, voltage dropping, areas and the like at the chip level.

Also, since the virtual flat placement processing is executed while the shape and area of a black-box block are kept fixed, the degree of freedom of the placement positions of logic cells, memories and the like in blocks other than the black-box block will be restricted. Therefore, the determination of the shape and area of each of the blocks other than the black-box block will be absolutely affected by the shape and area of the black-box block, and thus fail to reflect influences of the routing, timing, voltage dropping, areas and the like at the chip level.

As described above, the automatic floorplanning approach adopting the virtual flat placement technology will find difficulty in determining the placement position, shape and area of each block to be optimum when viewed from the chip level after assembling of the divided blocks if a block in the state of a so-called black box is involved.

### SUMMARY OF THE INVENTION

An object of the present invention is providing an automatic floorplanning approach adopting the virtual flat placement technology involving a black-box block, capable of determining the placement position, shape and area of each block to be optimum when viewed from the chip level more easily.

To overcome the problem described above, the present invention provides a floorplanning approach in hierarchical layout design using the virtual flat placement technology described above. In this approach, for the purposes of enabling the shape and area of a black-box block set in advance to reflect influences of routing, timing, voltage dropping, areas and the like at the chip level and preventing the shape and area of a black-box block set in advance from exerting absolute influence on determination of the shape and area of any block (white-box block) other than the black-box block, a core region in the shape of a polygon or the like is provided inside the black-box block, and the virtual flat placement is performed permitting placement position overlap between the black-box block and components such as logic cells and memories belonging to any white-box block for the region of the black-box block other than the core region. Also, by checking the overlap status in placement position, the shape and area of the black-box block set in advance are automatically changed according to the overlap status. The processing of the virtual flat placement permitting placement position overlap and the processing of the automatic change of the shape and area of the black-box block are repeated alternately until a predetermined condition is satisfied.

By permitting placement position overlap between the black-box block and components such as logic cells and memories belonging to any white-box block, the influence of the shape and area of the black-box block set in advance on determination of the shape and area of any block other than the black-box block, which was absolute, can be made flexible. Also, by automatically changing the shape and area of the black-box block set in advance according to the overlap status in placement position, the shape and area of the black-box block can be determined reflecting influences of routing, timing, voltage dropping, areas and the like at the chip level. Moreover, by repeating the processing of the virtual flat placement permitting placement position overlap and the processing of the automatic change of the shape and area of the black-box block alternately until a predetermined condition is satisfied, more optimal floorplan design can be achieved.

### BRIEF DESCRIPTION OF THE DRAWINGS

FIG. 1 is a flowchart of an automatic floorplanning approach of the present invention.

FIG. 2 is a flowchart of a flat placement processing section of the automatic floorplanning approach of the present invention.

FIGS. 3A and 3B are diagrams showing the states of floorplanning in the flat placement processing section of the automatic floorplanning approach of the present invention, in which FIGS. 3A and 3B shows the states during and after the flat placement processing, respectively.

FIG. 4 is a flowchart of a black-box block shape/area change processing section of the automatic floorplanning approach of the present invention.

FIGS. 5A to 5C are diagrams showing the states of floorplanning in the black-box block shape/area change processing section of the automatic floorplanning approach of the present invention, in which FIGS. 5A, 5B and 5C show the states before, during and after the processing, respectively.

FIG. 6 is a flowchart of a floorplanning approach considering delay margin information in hierarchical layout design involving a black-box block according to the present invention.

FIGS. 7A to 7D are diagrams showing the states of floorplanning in hierarchical layout design involving a black-box block according to the present invention, in which FIG. 7A shows the relationship among blocks, FIG. 7B shows the state after the flat placement, FIG. 7C shows the state after the black-box block shape/area change for the placement position overlap portion, and FIG. 7D shows the state after the black-box block shape/area change satisfying block restrictions.

FIG. 8 is a flowchart of a floorplanning approach considering line congestion information in hierarchical layout design involving a black-box block according to the present invention.

FIG. 9 is a flowchart of a floorplanning approach considering power consumption information in hierarchical layout design involving a black-box block according to the present invention.

FIG. 10 is a flowchart of a floorplanning approach considering block placement priority information in hierarchical layout design involving a black-box block according to the present invention.

### DESCRIPTION OF THE PREFERRED EMBODIMENTS

Hereinafter, preferred embodiments of the present invention will be described with reference to the accompanying drawings.

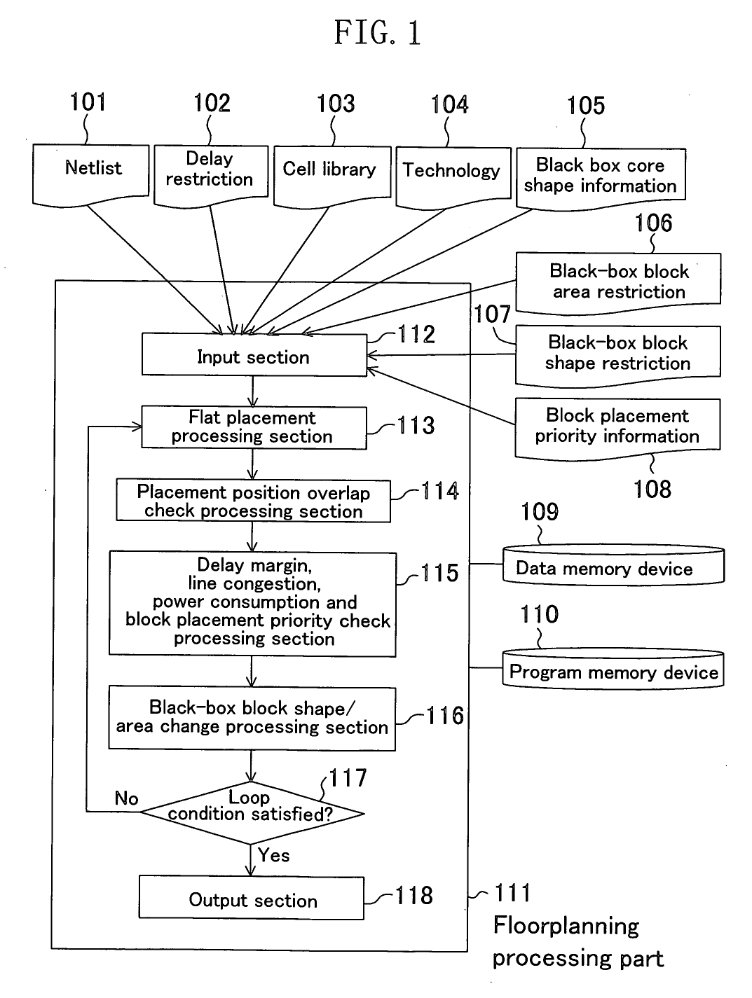

FIG. 1 shows a configuration of an automatic floorplanning apparatus for a semiconductor integrated circuit and a flowchart of an automatic floorplanning approach according to the present invention. Referring to FIG. 1, a floorplanning processing part 111 receives various types of information 101 to 108 via an input section 112. Input data and midway processing results are stored in a data memory device 109 while processing programs are stored in a program memory device 110.

A flat placement processing section 113 performs, based on the input data, placement processing in which placement position overlap between a black-box block and logic cells and the like expanded flatly neglecting the hierarchical structure is permitted in consideration of black box core shape information 105.

A placement position overlap check processing section 114 checks the overlap status in placement position between the black-box block and logic cells and the like expanded flatly neglecting the hierarchical structure after the flat placement processing.

A delay margin, line congestion, power consumption and block placement priority check processing section 115 checks the delay margin, the degree of line congestion, the power consumption and input block placement priority information 108.

A black-box block shape/area change processing section 116 changes the shape and area of the black-box block based on the information checked by the placement position overlap check processing section 114 and the information checked by the delay margin, line congestion, power consumption and block placement priority check processing section 115, according to the black box core shape information 105, black-box block area restriction 106 and black-box block shape restriction 107.

A determination section 117 checks a loop condition such as the number of times of flat placement processing and the processing time, for example, and sends the processing back to the flat placement processing section 113 if the loop condition is not satisfied, or to an output section 118 if the loop condition is satisfied.

The output section 118 outputs the results of the processing by the floorplanning processing part 111.

In FIG. 1, the reference numerals 101, 102, 103 and 104 respectively denote information representing a netlist, delay restriction, a cell library and technology.

<Flat placement processing section 113>

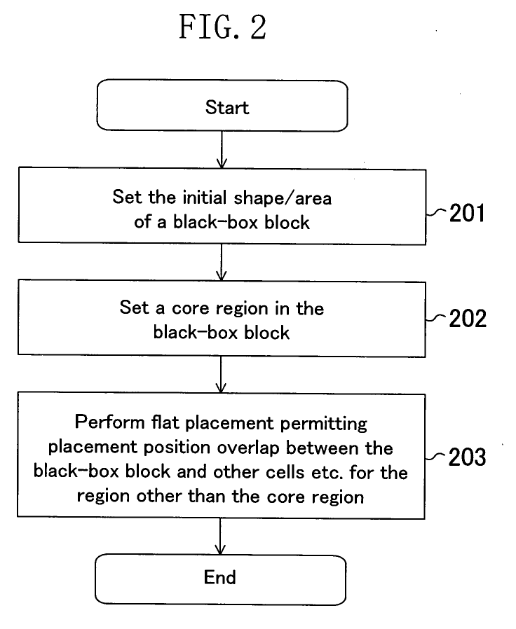

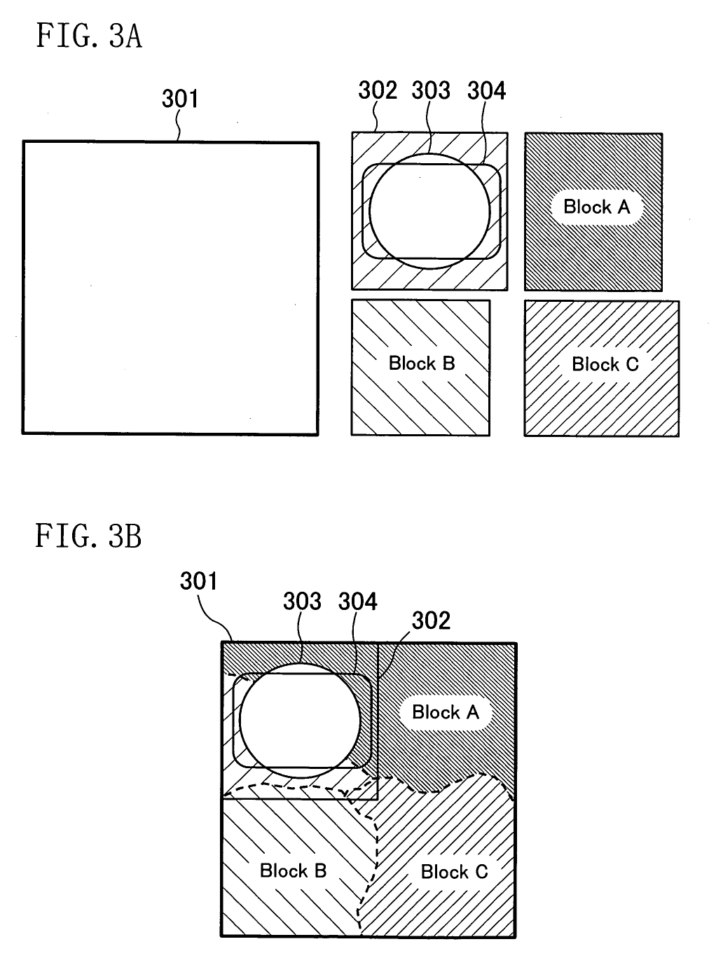

The flat placement processing section 113 will be described with reference to the flowchart of FIG. 2 and FIGS. 3A and 3B. First, the initial shape and area of a black-box block are set (step 201).

Thereafter, as shown in FIG. 3A, inside a black-box block 302, a black-box block core region 303 is set in the shape of a circle, for example, according to the black box core shape information 105, and a black-box block shape restriction 304 is set in the shape of a corner-rounded rectangle, for example, according to the black-box block shape restriction 304 (step 202). The reference numeral 301 denotes the frame at the top level (for example, the chip shape) in which the floorplanning approach in hierarchical layout design is to be performed.

Finally, flat placement processing is performed permitting placement position overlap between the black-box block and other logic cells and the like for the region of the black-box block other than the core region 303 (step 203). The resultant placement after the flat placement processing is as shown in FIG. 3B.

<Black-box block shape/area change processing section 116>

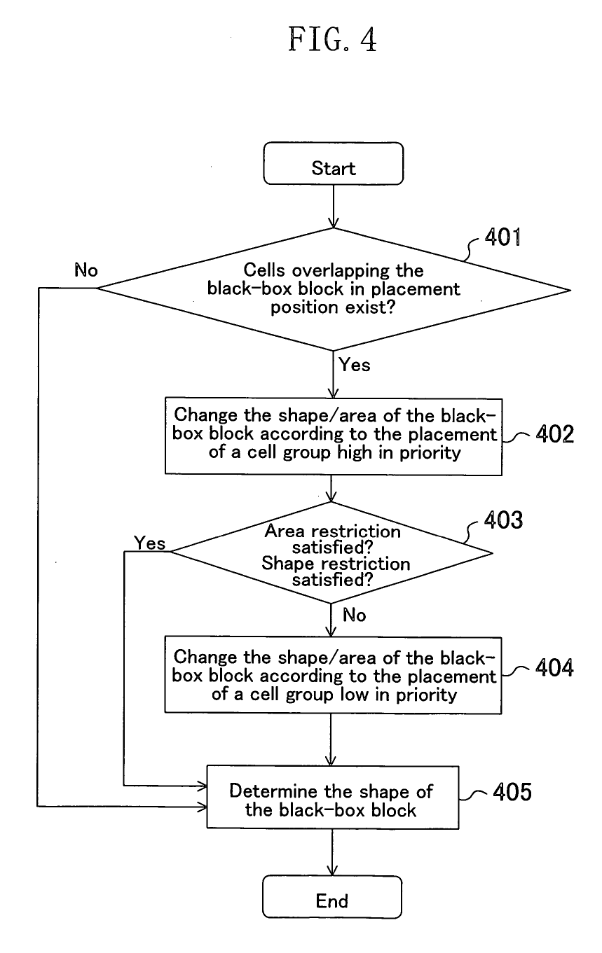

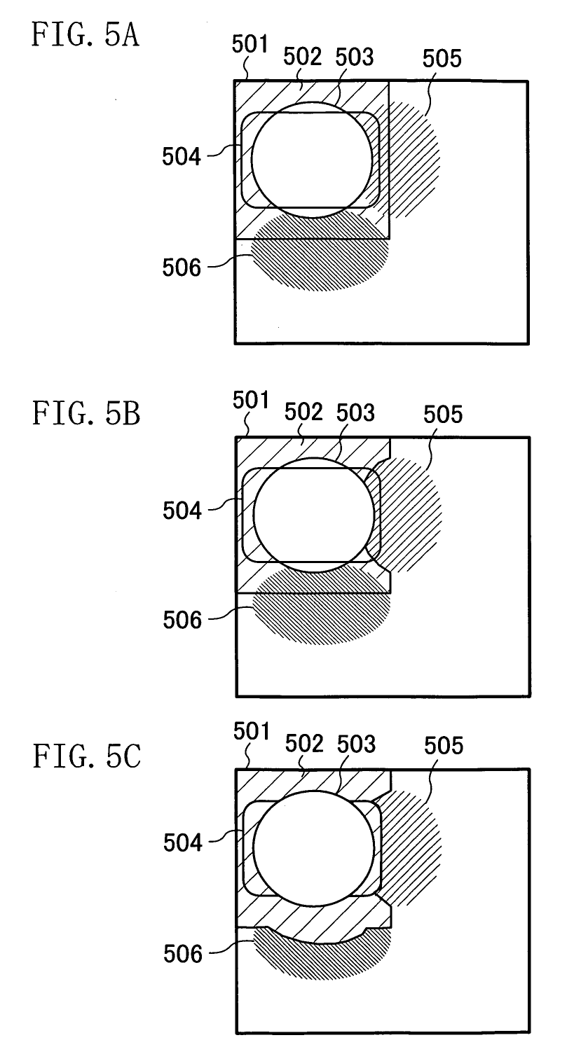

The black-box block shape/area change processing section 116 will be described with reference to the flowchart of FIG. 4 and FIGS. 5A to 5C. Based on the resultant placement from the flat placement processing section 113, whether or not logic cells overlapping the black-box block in placement position exist is checked (step 401). If no such logic cells exist, the shape and area of the black-box block are determined to be the initial ones set in the step 201 (step 405). If such logic cells exist, the process proceeds to step 402. In the case that cell groups 505 and 506 determined to be high and low in priority, respectively, by the delay margin, line congestion, power consumption and block placement priority check processing section 115, for example, overlap with the black-box block 502 as shown in FIG. 5A, the shape and area of the black-box block 502 are changed to be concave as shown in FIG. 5B according to the placement of the cell group 505 high in priority (step 402). Note that in FIGS. 5A to 5C, the reference numeral 501 denotes the frame at the top level (for example, the chip shape) in which the floorplanning approach in hierarchical layout design is to be performed, and 504 denotes a black-box block shape restriction in the shape of a corner-rounded rectangle. Thereafter, whether or not the black-box block 502 changed in shape and area satisfies the black-box block area restriction 106 and the black-box block shape restriction 107 is checked (step 403). If both restrictions are satisfied, the shape of the black-box block 502 is determined (step 405). If the area restriction, for example, is not satisfied, the shape of the black-box block 502 is changed to increase the area by protruding toward the cell group 506 low in priority as shown in FIG. 5C to thus satisfy the restriction (step 404). The shape of the black-box block 502 is then determined (step 405).

Hereinafter, four specific cases (considering the delay margin information, the line congestion information, the power consumption information and the block placement priority information) will be described individually.

<Floorplanning approach considering delay margin information in hierarchical layout design involving black-box block>

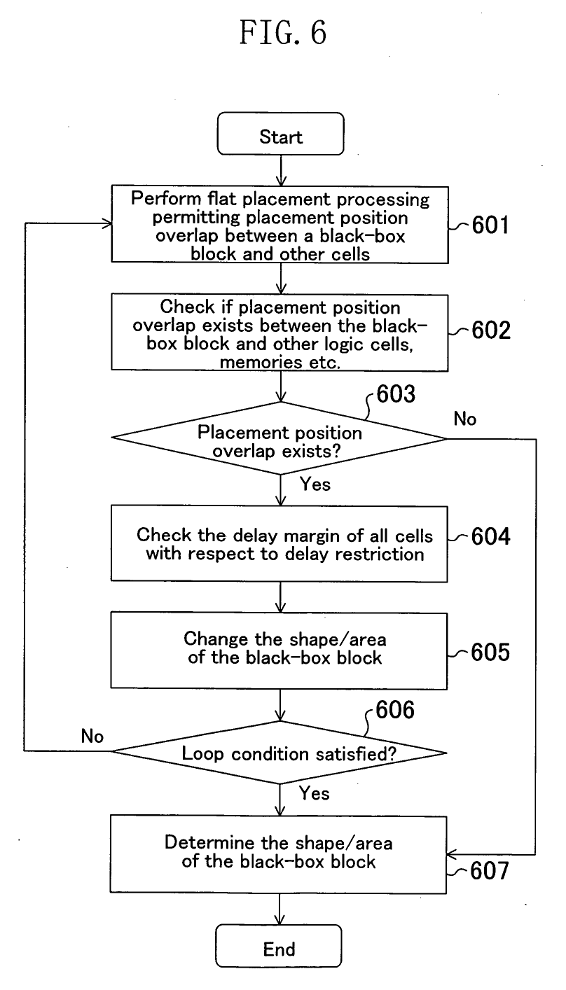

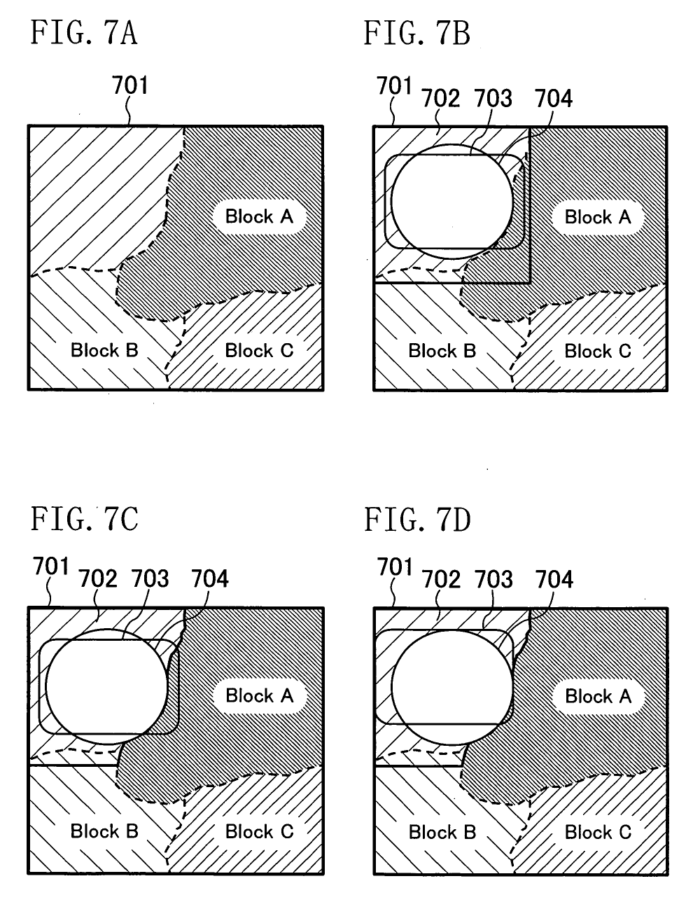

This approach will be described with reference to the flowchart of FIG. 6 and FIGS. 7A to 7D. In a semiconductor integrated circuit composed of one black-box block 702 and three hierarchical blocks A, B and C, assume that, to satisfy the chip-level delay restriction, it is necessary to not only place the blocks A, B and C on the upper right part, the lower left part and the lower right part of a chip 701, respectively, but also place some logic cells belonging to the block A near the block B, as shown in FIG. 7A when viewed from the level of the chip 701. Note that steps 601 to 607 in FIG. 6 roughly correspond to the sections 113 to 117 of the floorplanning processing part 111l shown in FIG. 1.

As a result of the flat placement processing 601 in FIG. 6, some logic cells belonging to the block A overlap the black-box block 702 in placement position to be located near the block B as shown in FIG. 7B. The reference numerals 703 and 704 respectively denote the black-box block shape restriction in the shape of a corner-rounded rectangle and the black-box block core region in the shape of a circle. If it is determined in the delay margin check step 604 that no delay margin is available for the logic cells in the block A overlapping the black-box block 702 in placement position, the shape and area of the black-box block 702 are changed to give high priority to the placement position of the block A as shown in FIG. 7C. In addition, as shown in FIG. 7D, further change is made according to the black-box block area restriction 106 and the black-box block shape restriction 107. Resultantly, the black-box block 702 is automatically changed to a shape considering the delay margin at the chip level, and in this way, more optimal floorplan design capable of suppressing occurrence of a timing-related problem at the chip level can be made easily.

<Floorplanning approach considering line congestion information in hierarchical layout design involving black-box block>

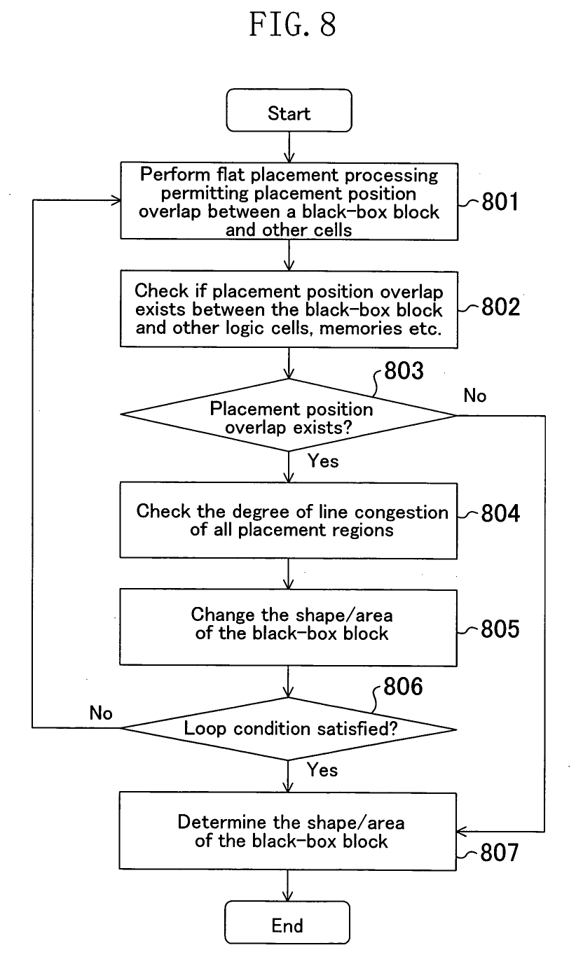

This approach will be described with reference to the flowchart of FIG. 8 and FIGS. 7A to 7D. In the semiconductor integrated circuit composed of one black-box block 702 and three hierarchical blocks A, B and C, assume that, to avoid chip-level line congestion, it is necessary to not only place the blocks A, B and C on the upper right part, the lower left part and the lower right part of the chip 701, respectively, but also place some logic cells belonging to the block A near the block B, as shown in FIG. 7A when viewed from the level of the chip 701. Note that steps 801 to 807 in FIG. 8 roughly correspond to the sections 113 to 117 of the floorplanning processing part 111 shown in FIG. 1.

As a result of the flat placement processing 801 in FIG. 8, some logic cells belonging to the block A overlap the black-box block 702 in placement position to be located near the block B as shown in FIG. 7B. If it is determined in the line congestion check step 804 that the degree of line congestion is high for the logic cells in the block A overlapping the black-box block 702 in placement position, the shape and area of the black-box block 702 are changed to give high priority to the placement position of the block A as shown in FIG. 7C. In addition, as shown in FIG. 7D, further change is made according to the black-box block area restriction 106 and the black-box block shape restriction 107. Resultantly, the black-box block 702 is automatically changed to a shape considering the degree of line congestion at the chip level, and in this way, more optimal floorplan design capable of suppressing line congestion at the chip level can be made easily.

<Floorplanning approach considering power consumption information in hierarchical layout design involving black-box block>

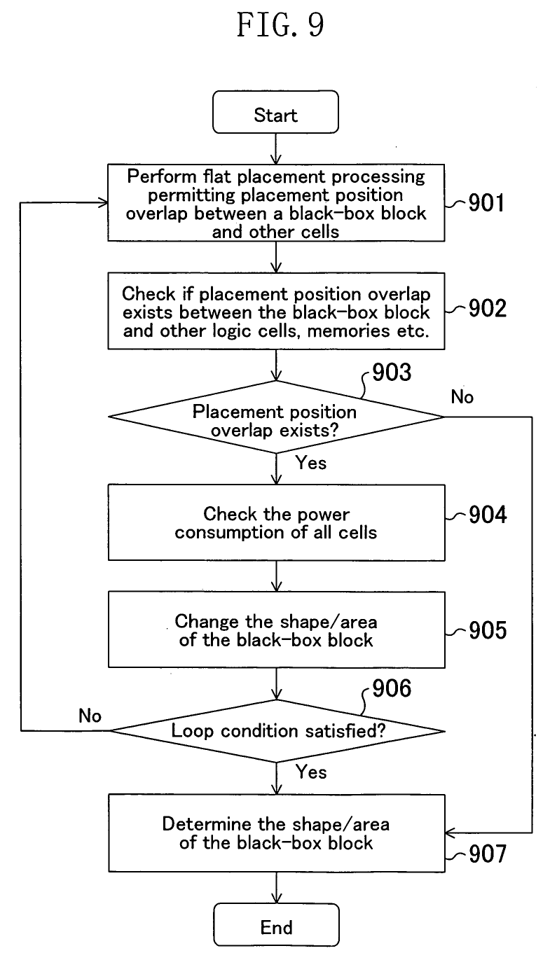

This approach will be described with reference to the flowchart of FIG. 9 and FIGS. 7A to 7D. In the semiconductor integrated circuit composed of one black-box block 702 and three hierarchical blocks A, B and C, assume that some cells in the block A consume large power and to avoid local voltage dropping at the chip level, a large placement area must be secured for the block A to ensure connection to more power supply lines arranged in a mesh or in stripes. Note that steps 901 to 907 in FIG. 9 roughly correspond to the sections 113 to 117 of the floorplanning processing part 111 shown in FIG. 1.

As a result of the flat placement processing 901 in FIG. 9, some logic cells belonging to the block A overlap the black-box block 702 in placement position as shown in FIG. 7B. If it is determined in the power consumption check step 904 that the power consumption is great for the logic cells in the block A overlapping the black-box block 702 in placement position, the shape and area of the black-box block 702 are changed to give high priority to the placement position of the block A as shown in FIG. 7C. In addition, as shown in FIG. 7D, further change is made according to the black-box block area restriction 106 and the black-box block shape restriction 107. Resultantly, the black-box block 702 is automatically changed to a shape considering local voltage dropping at the chip level, and in this way, more optimal floorplan design capable of suppressing local voltage dropping at the chip level can be made easily.

<Floorplanning approach considering block placement priority information in hierarchical layout design involving black-box block>

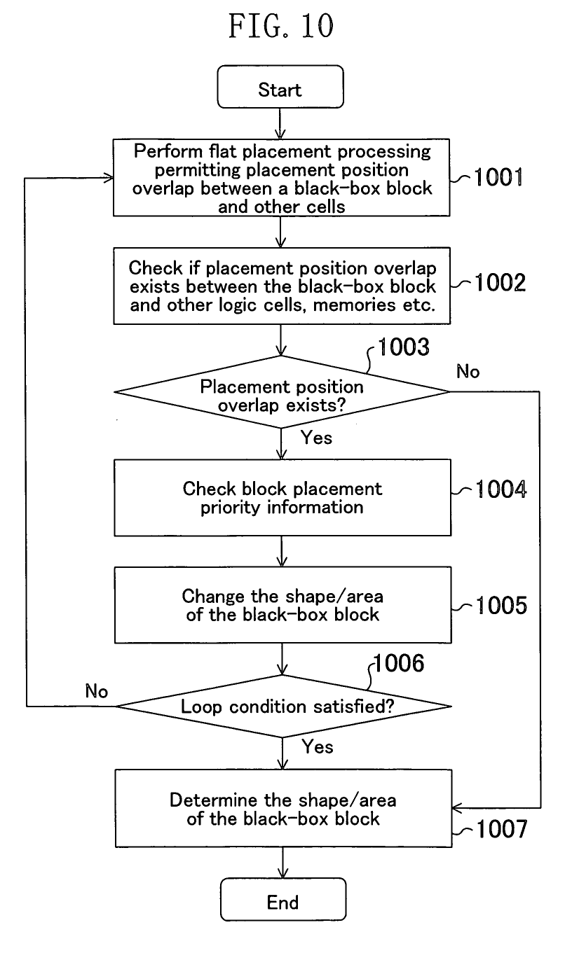

This approach will be described with reference to the flowchart of FIG. 10 and FIGS. 7A to 7D. In the semiconductor integrated circuit composed of one black-box block 702 and three hierarchical blocks A, B and C, assume that it is known in advance that, to avoid occurrence of a timing-related problem at the chip level, for example, high priority must be given to the placement position of the block A because the block A is higher in operating frequency than the other blocks. Note that steps 1001 to 1007 in FIG. 10 roughly correspond to the sections 113 to 117 of the floorplanning processing part 111 shown in FIG. 1.

As a result of the flat placement processing 1001 in FIG. 10, some logic cells belonging to the block A overlap the black-box block 702 in placement position as shown in FIG. 7B. If it is determined in the block placement priority check step 1004 that the priority is high for the logic cells in the block A overlapping the black-box block 702 in placement position based on the input block placement priority information 108, the shape and area of the black-box block 702 are changed to give high priority to the placement position of the block A as shown in FIG. 7C. In addition, as shown in FIG. 7D, further change is made according to the black-box block area restriction 106 and the black-box block shape restriction 107. Resultantly, the black-box block 702 is automatically changed to a shape considering the input block placement priority information 108, and in this way, more optimal floorplan design capable of suppressing occurrence of a problem at the chip level can be made easily.

As described above, the automatic floorplanning approach for a semiconductor integrated circuit according to the present invention can determine an optimum block shape in hierarchical layout design more easily, and thus is useful as an automatic floorplanning approach capable of shortening the design time period of a semiconductor integrated circuit, for example.

What is claimed is:

1. A floorplanning approach in hierarchical layout design of a semiconductor integrated circuit essentially composed of one or more black-box blocks each having at least input/output information at the block boundaries, the shape and area of the black-box block being set in advance, and one or more white-box blocks each having not only input/output information at the block boundaries but also information on components inside the block and connections for the components, the floorplanning approach determining the shape and area of a block based on result information of flat placement obtained by expanding a hierarchical structure, the approach comprising the steps of:
(1) setting a shape of a polygon, a circle or an ellipse inside the black-box block as a core region of the black-box block, and performing the flat placement permitting placement position overlap between the black-box block and a component inside the hierarchy-expanded white-box block for the region of the black-box block other than the core region;
(2) checking placement position overlap between the black-box block and a component inside the white-box block; and
(3) changing the shape and area of the black-box block from those set in advance according to the overlap status,
wherein the steps (1) to (3) are repeated in turn until a set condition is satisfied.

2. The automatic floorplanning approach of claim 1, comprising the step of changing the shape and area of the black-box block from those set in advance according to restrictions of the maximum increase amount and maximum decrease amount of the set area so as not to have a shape of an extremely large area or an extremely small area.

3. The automatic floorplanning approach of claim 1, comprising the step of changing the shape and area of the black-box block from those set in advance according to a restriction that the set shape of a polygon, a circle or an ellipse is the minimum shape of the black-box block so as not to have a shape of such an extremely large aspect ratio or an extremely small aspect ratio that makes the layout design difficult.

4. The automatic floorplanning approach of claim 1, comprising the steps of:
checking the delay margin of components inside all the white-box blocks with respect to a delay restriction of the semiconductor integrated circuit in the flat placement results; and
if a component recognized as small in delay margin in the step of checking the delay margin overlaps the black-box block in placement position, improving the delay margin by changing the shape and area of the black-box block from those set in advance to expand the placement allowable region for the component small in delay margin.

5. The automatic floorplanning approach of claim 1, comprising the steps of:
checking the degree of line congestion in placement regions of components inside all the white-box blocks in the flat placement results; and
if a component recognized as high in the degree of line congestion in the step of checking the degree of line congestion overlaps the black-box block in placement position, improving the degree of line congestion by changing the shape and area of the black-box block from those set in advance to expand the placement allowable region of the component high in the degree of line congestion.

6. The automatic floorplanning approach of claim 1, comprising the steps of:
checking the power consumption of components inside all the white-box blocks in the flat placement results; and
if a component recognized as large in power consumption in the step of checking the power consumption overlaps the black-box block in placement position, improving local voltage dropping occurring due to large power consumption by changing the shape and area of the black-box block from those set in advance to expand the placement allowable region of the component large in power consumption to thereby increase connection to power supply lines arranged in a mesh or in stripes.

7. The automatic floorplanning approach of claim 1, comprising the step of changing the shape and area of the black-box block from those set in advance according to set block placement priority information.

8. The automatic floorplanning approach of claim 1, comprising the step of changing the shape and area of the black-box block from those set in advance based on two or more among the delay margin of components inside all the white-box blocks with respect to a delay restriction of the semiconductor integrated circuit in the flat placement results, the degree of line congestion in placement regions of components inside all the white-box blocks in the flat placement results, the power consumption of components inside all the white-box blocks in the flat placement results and set block placement priority information, according to the priorities set for the delay margin, the degree of line congestion, the power consumption and the block placement priority information.

9. An automatic floorplanning program, wherein processing is performed by a processor with the automatic floorplanning approach of claim 1 stored in a program memory device and floorplanning data stored in a data memory device.

10. An automatic floorplanning apparatus for executing the automatic floorplanning approach of claim 1.

11. A semiconductor integrated circuit designed using the automatic floorplanning approach of claim 1.
